(19) United States
(12) Patent Application Publication
(10) Pub. No.: US 2012/0017497 A1
(43) Pub. Date: Jan. 26, 2012

(54) METHOD AND DEVICE FOR UTILIZING BIOMASS IN A BIOMASS GASIFICATION PROCESS

(76) Inventors: Helmut Kammerloher, Freising (DE); Sven Johannssen, Regensburg (DE); Van Cung Tran, Sulzbach-Rosenberg (DE)

(21) Appl. No.: 13/254,799

(22) PCT Filed: Mar. 3, 2010
(86) PCT No.: PCT/EP2010/052655

§ 371 Date: Oct. 5, 2011

(30) Foreign Application Priority Data
Mar. 5, 2009 (DE) 10 2009 011 358.4

(51) Int. Cl. C10L 1/12; B01J 10/00; C10J 3/46

(52) U.S. Cl. 44/457; 48/197 R; 422/187

(57) ABSTRACT

The invention relates to a method for utilizing biomass, wherein the following steps are performed: First, at least one raw material containing carbon is thermally gasified. In a next step, the synthesis gas produced in the gasification is purified. During said purification, the temperature of the synthesis gas is changed. Then the synthesis gas is preferably converted into a liquid fuel by means of a catalyzed chemical reaction, wherein a straw-like biomass is selected as the raw material containing carbon, the gasification is performed in a fixed bed reactor, and the ash-softening temperature of the straw-like raw material is increased by adding at least one alkaline-earth salt.

The invention relates to a method and a device for utilizing biomass in a (thermal) biomass gasification process in accordance with the preambles of claims 1, 9 and 10, and in particular to a method for increasing the ash softening temperature of stalk-type biomass.

The invention relates to the production of BtL (biomass to liquid) fuels. This term denotes those fuels which are synthesised from biomass. In contrast to biodiesel, BtL fuel is generally obtained from solid biomass, such as for example firewood, straw, biowaste, meat and bone meal or reeds, i.e. from cellulose or hemicellulose, and not just from vegetable oil or oil seeds.

The great advantages of this synthetic biofuel are its high yields in terms of biomass and area, of up to 4000 l per hectare, without competing with foodstuffs in this respect. In addition, this fuel has a high CO₂ reduction potential of over 90%, and its high quality is not subject to any restrictions as to use in today's and foreseeable generations of engines.

Usually, in the production of BtL fuels, in a first process step gasification of biomass is carried out, as is subsequent production of synthesis gas. The latter is synthesised at elevated pressure and elevated temperature to produce the liquid fuel.

Owing to the rising prices for wood-type fuels, stalk-type biomass, for example wheat straw, rape straw or meadow hay, is gaining in importance as a fuel. However, straw has distinctly different properties from, for example, wood in the combustion process or gasification process.

In addition, various gasifiers are known from the prior art, such as for example autothermal fixed-bed gasifiers or alternatively autothermal entrained-flow gasifiers (cf. SunDiesel—made by Choren—Erfahrungen and neueste Entwicklungen, Matthias Rudloff in “Synthetische Biokraftstoffe”, series “nachwachsende Rohstoffe”, Volume 25, Landwirtschaftsverlag GmbH, MUnster 2005).

For example, fluidised-bed gasifiers according to the “Gussing principle” are known from the prior art. Therein, the necessary gasification energy is applied by supplying hot sand (at a temperature of 950° C.). The preheating of this sand is again brought about by the combustion of the raw material used (in this case biomass). Thus here too the valuable raw material is used as an energy source, which reduces the specific yield.

Furthermore, according to EP 1 837 390 A1 the treatment of biological fuel material, in particular untreated wood, by the addition of burnt lime is known, wherein an improved degree of dryness of the raw materials is reportedly achieved utilising the hygroscopic action of the burnt lime.

The treated fuel material is processed further after the mixing with burnt lime to form solid shaped pieces.

DE 198 36 428 C2 describes methods and devices for the gasification of biomass, in particular of wood materials. Therein, fixed-bed gasification takes place at temperatures of up to 600° C. in a first gasification stage, and fluidised-bed gasification takes place at temperatures between 800° C. and 1000° C. in a subsequent second gasification stage.

A method for producing combustible gases and synthesis gases with high-pressure steam generation is known from DE 10 2005 006305 A1. With this method, gasification processes in an entrained-flow gasifier at temperatures below 1200° C. are used.

Owing to its high chloride and potassium content, the ash softening temperature of wheat straw is approximately 800° C., and hence considerably below that of wood, at approximately 1200° C. Disadvantageously, this results, at reactor temperatures greater than approximately 800° C., in the ash of stalk-type biomass changing into a soft, pasty slag, which leads to lumping in the reactor.

It is therefore the object of the present invention to make available a method and a device for efficient gasification of carbon-containing raw materials, in particular stalk-type raw materials, which permits gasification of the raw material at higher temperatures, and in particular avoids clumping of the biomass.

In addition, the device according to the invention should also be suitable overall for smaller capacities and possibly decentralised operation with different feed materials, in order to attain good profitability and to be usable both for autothermal and for autothermal gasification.

This is achieved by a method according to claim 1 and a device according to claim 9. Advantageous embodiments and developments are the subject of the dependent claims.

In a method according to the invention for increasing the ash softening temperature of carbon-containing raw materials, the following steps are carried out: First the thermal gasification of at least one carbon-containing raw material is carried out. In a next step, the cleaning of the synthesis gas resulting from gasification takes place. In so doing, a change in temperature in the synthesis gas is carried out.

According to the invention, a stalk-type biomass is selected as carbon-containing raw material, the gasification is preferably carried out in a fixed-bed reactor, and the ash softening temperature of the stalk-type raw material is increased by the addition of at least one alkaline-earth salt.

A stalk-type raw material is understood to mean in particular a raw material which is selected from a group of raw materials which contains grasses, straw, hay, reeds, rape straw, wheat straw, combinations thereof or the like.

The combination according to the invention of the use of a fixed-bed reactor for the stalk-type biomass and the addition of the alkaline-earth salt, as has been shown in costly investigations, yields particular synergistic effects. A fixed-bed reactor offers the advantage that the flow can pass through it both from above and from below. Furthermore, in the case of a fixed-bed reactor, discharging of the product is relatively simple. In such case, also the discharging of the ash is considerably simplified due to the increase in the ash softening temperature mentioned.

Preferably the conversion of the synthesis gas into a liquid fuel by means of a catalysed chemical reaction then takes place, i.e. in particular after the temperature change of the synthesis gas.

Preferably the alkaline-earth salt is selected from the group consisting of calcium and/or magnesium and also carbonate, hydroxide, hydrogen carbonate and/or oxide.

Particularly preferably, the alkaline-earth salt is added in the form of burnt lime (CaO) and/or slaked lime (Ca(OH)₂) and/or calcium carbonate (CaCO₃) and/or calcium hydrogen carbonate (Ca(HCO₃)₂) during, and optionally also prior to, the thermal gasification. In such case, also mixtures of the aforementioned substances may be used. The amount of added alkaline-earth salt is preferably 0.1-10.0% by weight, preferably 1.0-3.0% by weight, relative to the total weight of stalk-type raw material and alkaline-earth salt(s).

Preferably the alkaline-earth salt is added in the form of dolomite and/or limestone during, but optionally also prior to, the thermal gasification. In particular, the operating temperature in the gasifier is kept above the ash fusion temperature of the stalk-type raw material.

Preferably the ash softening temperature of the stalk-type raw material is lower than that of wood or is selected to be lower, the ash softening temperature of the stalk-type raw material prior to the addition of the alkaline-earth salt being established in a range from 600° C. to 1000° C., preferably in a range from 700° C. to 900° C., particularly preferably at approximately 800° C.

Advantageously, the waste heat from at least one process following the gasification is used for generation of saturated steam.

The present invention is furthermore directed at methods for utilizing carbon-containing raw materials, wherein thermal gasification of at least one carbon-containing raw material takes place. According to the invention, a stalk-type biomass is selected as carbon-containing raw material, the gasification is carried out in a fixed-bed reactor and the ash softening temperature of the stalk-type raw material is increased by the addition of at least one alkaline-earth salt. Preferably the method is carried out in the manner described above.

A device according to the invention for the conversion of carbon-containing raw materials, in particular of biomass, into liquid fuels or into gases which can be utilised further contains a gasifier in which the carbon-containing raw materials are gasified, at least one cleaning unit for cleaning of the synthesis gas produced upon the gasification, at least one temperature change unit for changing the temperature of the resulting synthesis gas, and also preferably a conversion unit for conversion of the synthesis gas into a liquid fuel, the carbon-containing raw material containing at least one stalk-type raw material, the ash softening temperature of which is increased by the addition of at least one alkaline-earth salt.

Preferably the gasifier is a fixed-bed reactor.

In particular, the ash of the stalk-type raw material can be removed continuously from the fixed-bed reactor. Preferably the device has a supply means which supplies the alkaline-earth salt to the raw material. This supply means in this case advantageously permits metered addition of the alkaline-earth salt to the raw material or the biomass, continuous addition during a running gasification process also being possible.

In addition, the gasification of the stalk-type raw material in the fixed-bed reactor can be carried out both allothermally and autothermally.

Thus the method according to the invention is divided into at least 3 process steps, with first for example allothermal gasification of the raw material such as biomass and in particular straw or wheat straw and/or rape straw for example with steam, which serves as a gasification agent and energy source, being carried out. In the subsequent cleaning process, cleaning of the gas in particular from dust and tar and preferably subsequent returning of these substances into the gasification process is carried out. In the context for example of a Fischer-Tropsch synthesis, synthesis gas is converted into liquid fuels.

In order to achieve complete gasification, it is necessary for the steam used to be at a temperature which is considerably above the average gasification temperature. Therefore temperatures of at least 1000° C., but preferably temperatures of more than 1200° C., are used.

Owing to the recuperative heat exchangers used in the prior art, it has hitherto not been possible to attain such steam temperatures. However, bulk generators may be used, as have been described for example in EP 0 620 909 B1 or DE 42 36 619 C2. The content of the disclosure of EP 0 620 909 B1 and of DE 42 36 619 C2 is hereby fully incorporated by reference in the present disclosure. The use of such bulk regenerators results in a more efficient device compared with the prior art.

In a further preferred method, the maximum temperature within the gasifier is always above the ash fusion temperature of the raw material. In this manner, ash can be discharged in the liquid state.

Preferably the gasifier is a counter-current fixed-bed gasifier. In principle, various gasifier types according to the prior art can be used. The particular advantage of a counter-current fixed-bed gasifier is, however, that individual zones form within this reactor, in which zones different temperatures and hence different processes occur. The different temperatures are based on the fact that the respective processes are highly endothermic and the heat comes only from below. In this manner, the very high steam temperatures are exploited in a particularly advantageous manner. Since the highest steam temperatures prevail in the entry zone of the gasification agent, it is possible always to produce the conditions for liquid ash discharge.

This is particularly advantageous in the gasification of biomass, because in this case the ash fusion temperatures differ very greatly depending on the type of fuel and the soil properties.

In the prior art, it has not been possible hitherto to convert different fuels with a given gasifier type and thus to adapt to the market situation. Owing to the high temperatures, it is however possible in principle according to the invention to configure the process such that the ash produced is always discharged in liquid form. In those cases in which the ash fusion temperature is particularly high, preferably a specified amount of fluxing agent can be added to the fuel. Owing to the simultaneous introduction of oxygen or air described above, a further temperature increase in the ash discharge zone can be achieved.

Preferably the waste heat from at least one process following the gasification is used for generation of saturated steam. In such case, it is for example possible to utilise the waste heat from the gas cooler described for preheating the water for the generation of saturated steam. Furthermore, also the waste heat produced in the Fischer-Tropsch reactor itself can be utilised for the generation of the saturated steam. The exothermic synthesis reaction in the Fischer-Tropsch reactor requires constant and uniform cooling. Preferably in this case the cooling is carried out with boiling water and subsequent generation of saturated steam.

Further advantages and embodiments will become apparent from the appended drawings:

These show:

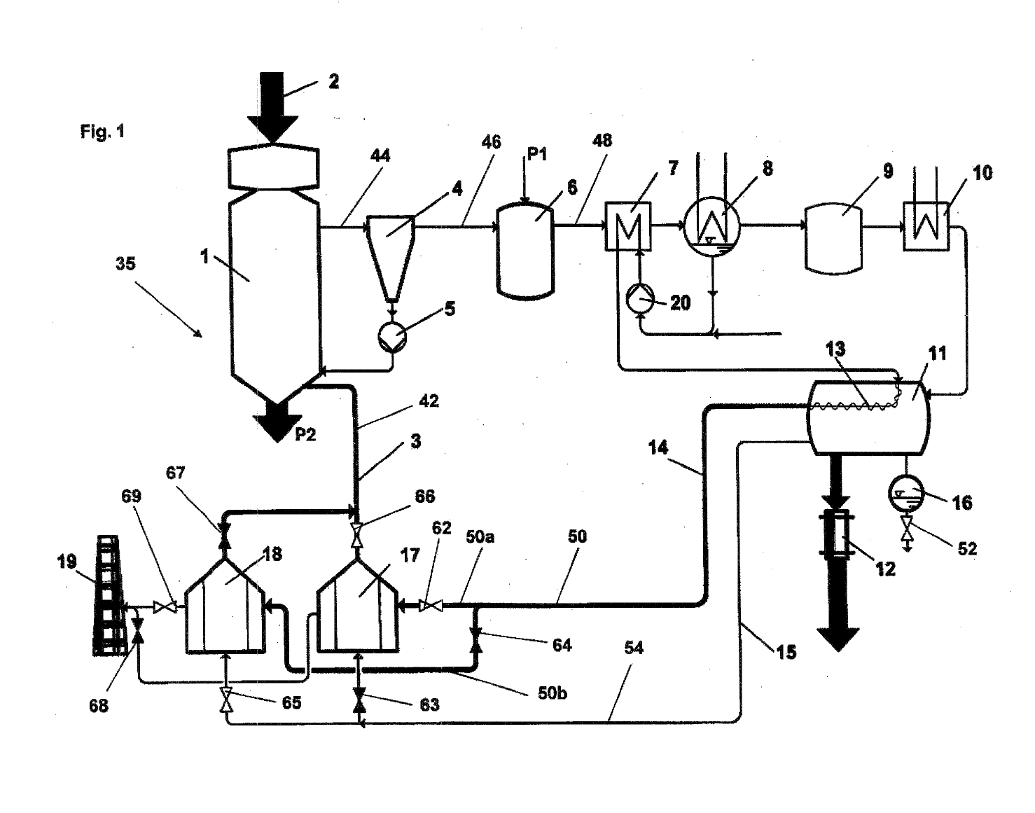

FIG. 1 a diagrammatic representation of a device according to the invention; and

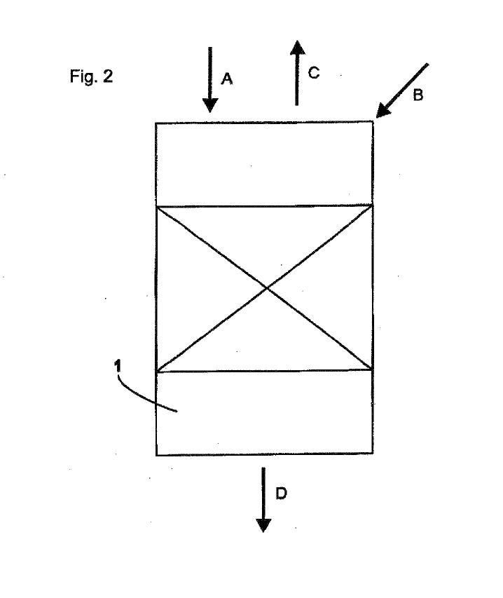

FIG. 2 a diagrammatic illustration of a method according to the invention.

FIG. 1 shows a diagrammatic illustration of a device 35 for the conversion of carbon-containing raw materials into synthesis gas and for the subsequent liquid fuel synthesis. However, it is pointed out that the device shown in FIG. 1 is only by way of an example, and the present invention can also be applied to other installations which comprise a gasifier.

In this case, reference numeral 1 refers to a counter-current fixed-bed reactor. The raw material 2 is introduced into the reactor 1 from above, and the gasification agent 3 is introduced from below along a feed line 42. In this manner, the gasification agent 3 and the synthesis gas produced flow through the reaction chamber in the opposite direction to the flow of fuel. The ash produced in the gasifier 1 is discharged downwards, that is to say in the direction of the arrow P2.

Starting from the reactor 1, the synthesis gas passes via a line 44 into a cyclone, or preferably a multicyclone. In this cyclone 4, a major part of the tar and the dust produced is separated off and injected back into the high-temperature zone of the gasifier 1 using a pump 5. The synthesis gas which is pre-cleaned in this manner, in which residual tar is present together with residual amounts of dust, passes via a further line 46 into a thermal cracker 6. In this thermal cracker, the residual tar, with the amounts of dust, is destroyed at maximum temperatures of between 800° C. and 1400° C. Optionally, in order to obtain the necessary temperature, a specified amount of oxygen and/or air can be injected directly into the high-temperature zone, and in this manner partial oxidation of the tars can be achieved (see arrow P1).

After the thermal cracker, the synthesis gas passes via a line 48 into a gas cooler 7. In this gas cooler, the synthesis gas is cooled to such an extent that excess steam is condensed out in the subsequent condenser 8. Optionally, the amount of CO₂ in the synthesis gas can be reduced with the aid of a CO₂ scrubber 9 or a PSA/VSA system using molecular sieve technology. Additionally, residual amounts of pollutants (which are in the ppm range) can be completely removed, for example with the aid of a scrubber (not shown) using ZnO. Reference numeral 10 relates to a gas preheater, in which the synthesis gas is preheated to a suitable temperature for the subsequent Fischer-Tropsch synthesis which takes place.

Reference numeral 11 relates to a Fischer-Tropsch reactor, in which the synthetic liquid fuel 12, e.g. BtL in the case of the gasification of biomass, is produced from the synthesis gas under suitable thermodynamic conditions, that is to say at an appropriate pressure and temperature. As byproducts of this synthesis, saturated steam 14 is produced by cooling 13 of the reactor and an off-gas 15 is produced which consists of non-reacted synthesis gas and gaseous synthesis products. In addition, a water condensate 16 is also produced. This water condensate 16 can be drained off via a valve 52.

The saturated steam 14 then passes via a connecting line 50, which is split into two partial lines 50a and 50b, into two bulk regenerators 17 and 18. In these bulk regenerators, the steam is superheated to the necessary temperature. In the device shown in FIG. 1, two bulk regenerators 17, 18 are provided, which permit continuous operation of the installation. While the steam is being superheated in the bulk regenerator 17, the bulk regenerator 18 is in a heating-up phase, that is to say that it is here charged with thermal energy in particular by the combustion of off-gas 15, which is supplied thereto via a connecting line 54 from the Fischer-Tropsch reactor 11. A plurality of valves 62 to 69 is used for controlling the two bulk regenerators. In this case, the valves 62, 63, 66 and 68 are associated with the bulk regenerator 17, and the valves 64, 65, 67 and 69 with the bulk regenerator 18.

The combustion gases produced in each case leave the installation through a chimney 19. By periodically switching over the valves 62-69 shown, the two bulk regenerators 17 and 18 can be operated alternately. In this case it is also possible to generate the necessary steam from the condensate coming from the condenser 8. Dependent on the water content of the raw material 2, there is the possibility of using additional amounts of water, for example the condensate 16 from the Fischer-Tropsch reactor. Since the necessary amount of water is conveyed through the gas cooler 7 with the aid of the pump 20, preheating also takes place in this respect.

In the cooler 13 of the Fischer-Tropsch generator 11, likewise saturated steam 14 is generated, which again is superheated in the bulk regenerators 17 and 18, it being possible in this case to use the chemical energy from the off-gas 15. In this manner, the entire waste energy produced in the process is supplied to the superheated steam 3, and thus the steam can be heated particularly advantageously.

Instead of the two bulk regenerators 17, 18 shown in FIG. 1, also three or alternatively a plurality of bulk regenerators may be used in order to achieve particularly uniform operation.

FIG. 2 shows a diagrammatic representation to illustrate the method according to the invention. Therein, both the stalk-type biomass (arrow A) and the above mentioned alkaline-earth salt (arrow B) are supplied to a fixed-bed reactor. The supplying of the alkaline-earth salt may in this case take place both prior to and during the supplying of the biomass. Furthermore, it would be possible for the alkaline-earth salt to be mixed nr blended with the biomass within the reactor 1. The resulting gas is removed from the reactor 1 (arrow C) and also the ash produced upon the gasification is discharged from the reactor 1 (arrow D).

All the features disclosed in the application documents are claimed as essential to the invention, insofar as they are novel individually or in combination with respect to the prior art.

### LIST OF REFERENCE NUMERALS

1 counter-current fixed-bed reactor
2 raw material
3 steam
4 cyclone
5 pump
6 cracker
7 gas cooler
8 condenser
9 CO₂ scrubber
10 gas preheater
11 Fischer-Tropsch reactor
12 liquid fuel
13 cooler
14 saturated steam
15 off-gas
16 condensate
17, 18 bulk regenerators
19 chimney
20 pump
21 hot gas regulating valve
22 bypass line
23, 25 control valve
24 heat consumer
30 line
35 device
42 feed line
44, 46, 48 line
50a, 50b partial lines
52 valve
54 connecting line
62-69 valves
P1, P2, P3 arrows
A, B, C, D arrows

1. A method for utilizing carbon-containing raw materials, comprising the steps:
thermal gasification of at least one carbon-containing raw material;
cleaning of the synthesis gas resulting from the gasification;
change in temperature of the synthesis gas;
wherein
a stalk-type biomass is selected as carbon-containing raw material, the gasification is carried out in a fixed-bed reactor, and the ash softening temperature of the stalk-type raw material is increased by the addition of at least one alkaline-earth salt.

2. A method according to claim 1, wherein the alkaline-earth salt is selected from the group consisting of calcium and/or magnesium and also carbonate, hydroxide, hydrogen carbonate and/or oxide and also mixtures thereof.

3. A method according to claim 1, wherein the conversion of the synthesis gas into a liquid fuel takes place by means of a catalysed chemical reaction.

4. A method according to claim 1, wherein the alkaline-earth salt is added in the form of burnt lime (CaO) and/or slaked lime (Ca(OH)₂) and/or calcium carbonate (CaCO₃) and/or calcium hydrogen carbonate (Ca(HCO₃)₂) during the thermal gasification.

5. A method according to claim 1, wherein the alkaline-earth salt is added in the form of dolomite and/or limestone during the thermal gasification.

6. A method according to claim 1, wherein the operating temperature in the gasifier (1) is kept above the ash fusion temperature of the stalk-type raw material.

7. A method according to claim 1, wherein the ash softening temperature of the stalk-type raw material is lower than that of wood.

8. A method according to claim 1, wherein the ash softening temperature of the stalk-type raw material prior to the addition of the alkaline-earth salt lies in a range from 600° C. to 1000° C., preferably in a range from 700° C. to 900° C., particularly preferably at approximately 800° C.

9. A method according to claim 1, wherein the waste heat from at least one process following the gasification is used for generation of saturated steam.

10. A method for utilizing carbon-containing raw materials, wherein thermal gasification of at least one carbon-containing raw material takes place, wherein a stalk-type biomass is selected as carbon-containing raw material, the gasification is carried out in a fixed-bed reactor, and the ash softening temperature of the stalk-type raw material is increased by the addition of at least one alkaline-earth salt.

11. A device (35) for the conversion of carbon-containing raw materials, and in particular of biomass, into liquid fuels, with a gasifier (1) in which the carbon-containing raw materials are gasified, at least one cleaning unit (4, 6) for cleaning of the synthesis gas produced upon the gasification, at least one temperature change unit (7, 8, 10) for changing the temperature of the resulting synthesis gas, and a conversion unit (11) for conversion of the synthesis gas into a liquid fuel, wherein the carbon-containing raw material contains at least one stalk-type raw material, the ash softening temperature of which is increased by the addition of at least one alkaline-earth salt.

12. A device (35) according to claim 11, wherein the gasifier (1) is a fixed-bed reactor (1).

13. A device (35) according to claim 11, wherein the ash of the stalk-type raw material can be removed continuously from the fixed-bed reactor (1).

14. A device (35) according to claim 11, wherein the gasification of the stalk-type raw material in the fixed-bed reactor (1) can be carried out both allothermally and autothermally.
